(19) United States
(12) Patent Application Publication
(10) Pub. No.: US 2010/0265931 A1
(43) Pub. Date: Oct. 21, 2010

(54) Range-Based Wireless Alarm System

(76) Inventor: Peter Loc, Cupertino, CA (US)

Correspondence Address: Peter Loc, 10225 Glencoe Drive, Cupertino, CA, 95014, US

(21) Appl. No.: 12/717,150

(22) Filed: Mar. 4, 2010

Related U.S. Application Data
(60) Provisional application No. 61/157,379, filed on Mar. 4, 2009.

(51) Int. Cl. H04W 56/00; G08B 1/08

(52) U.S. Cl. 370/338; 340/539.1

(57) ABSTRACT

A range-based alarm system comprised of a controlling device and a plurality of portable, handheld devices communicating over a wireless local area network (WLAN); wherein the controlling device frequently computes the distance between itself and the plurality of portable, handheld devices and raises an audible or visual alarm when one of the computed distances exceeds its programmed operating range. An audible or visual alarm is also triggered on any of a plurality of portable, handheld devices when it has lost communication with the controlling device or when instructed by the controlling device.

### CROSS-REFERENCE TO RELATED APPLICATIONS

This application claims the benefit of U.S. Provisional Patent Application Ser. No. 61/157,379 entitled “Range-based wireless alarm system” filed Mar. 4, 2009, the disclosure thereof incorporated by reference herein in its entirety.

### FIELD OF THE INVENTION

The present invention relates generally to wireless local area network (WLAN) systems and more particularly relates to a method for a range-based alarm system utilizing the computed distances between a reference device and other devices as the trigger mechanism for alarm.

### BACKGROUND

Wireless interfaces are utilized ubiquitously in a variety of devices from cell phones to hand held devices to laptop computers to routers that connect to the internet via a hardwire, Ethernet cable. These interfaces are typically wireless local area network (WLAN) interfaces. At present time, these interfaces are mostly used for transferring data, exchanging music or video files between two devices.

It is desirable to utilize these WLAN interfaces for other applications such as security and telemetry. The fact that the signals transmitted from such devices are traveling in the air at the speed of light C (C=300,000 km/s). Therefore, the distance between two WLAN devices can be computed fairly accurately if the time it takes for the signal to be transmitted from one device to reach the other device is known. The accuracy of the computed distance depends largely on the following factors:
a. The accuracy of the clocks being used at the transmitter and receiver to record the time the signal is transmitted from the transmitter and the time the signal is received the receiver.
b. Assuming that the clocks running at the transmitter and receiver are very accurate, these clocks need to be synchronized so that the time the signal takes to travel from the transmitter to the receiver can be calculated by subtracting the time the receiver receives the signal from the time the signal is transmitted from the source.
c. Due to reflection of the signal from objects that are situated in between the transmitter and receiver, the signal may be reflected off many objects before getting to the receiver. The receiver usually locks into the strongest path to retrieve the signal. If the strongest path is not the direct path between the transmitter and receiver, it may arrive at the receiver a fraction of the time later than the signal that would have been arrived via the direct path. In this invention, this effect is considered minimal.

### SUMMARY OF THE INVENTION

The invention describes methods and apparatus for forming ranged-based wireless alarm systems that rely on the computed distances between two or more WLAN devices to trigger alarms. Accordingly, a system and method in accordance with the present invention enables a smart phone, handheld, laptop, router or the like, which is equipped with a WLAN interface, to monitor the distance between itself and one or more WLAN devices and raise an alarm if the computed distance is greater than a preset value. Other aspects and advantages of the present invention will become apparent from the following detailed description, taken in conjunction with the accompanying drawings, which illustrate by way of example the principles of the invention.

The invention enables people to maintain contact from one designated person to one or more persons in public places such as shopping malls, beaches, parks, ski slopes and at events such as festivals, outdoor concerts, and public gatherings. An alarm is raised when any contact is lost or when the distance between the designated person to any person in the group exceeds the preset distance.

The invention can also be used to monitor or display distances from a fixed, stationary device to objects such as cars, bicycles, people and animals that are equipped with WLAN interlaces within the operating range of WLAN, typically varied from 300 meters to 1000 meters. An alarm is raised if any of the measured distances exceeds a preset value.

### BRIEF DESCRIPTION OF THE DRAWINGS

FIG. 1A is a block diagram of an embodiment of a range-based wireless alarm system in accordance with the invention, wherein the devices shown are all mobile or handheld devices.

FIG. 1B is a block diagram of an embodiment of a range-based wireless alarm system in accordance with the invention, wherein the controlling device is installed at a fixed location and other devices are mobile devices.

FIG. 2 shows a flow chart describing the procedure to activate and arm a range-based alarm between the controlling device and another device, which is called tracking device, in accordance with the invention.

FIG. 3 shows the procedure to synchronize the time clocks of the controlling device and a tracking device in accordance with the invention, wherein both devices are mobile devices.

FIG. 4 shows the time sync procedure between the controlling device and a tracking device in accordance with the invention, wherein the controlling device is installed at a fixed location and the tracking device is a mobile device.

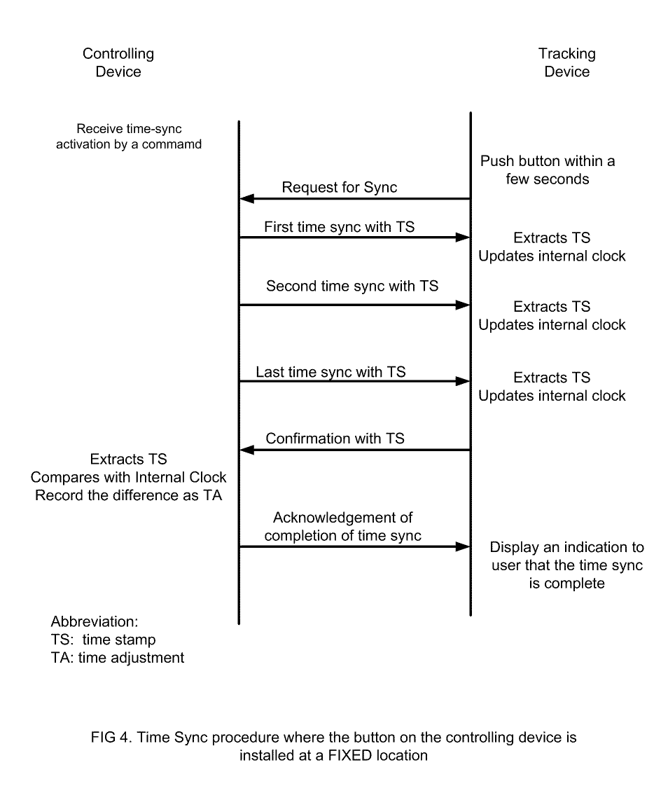

FIG. 5 shows the steps involved in the computation of the distance between the controlling device and a tracking device in accordance with the invention.

### DETAILED DESCRIPTION

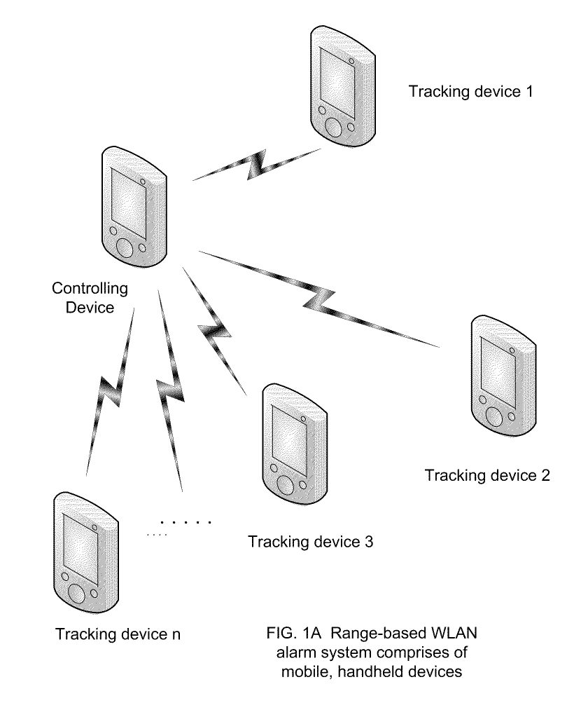

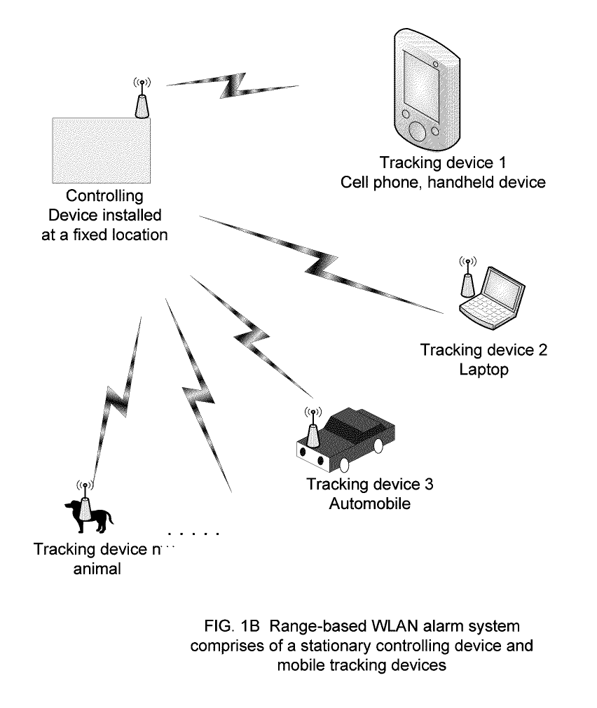

In one embodiment, the invention enables a group of mobile and handheld users to form a ranged-based alarm system (FIG. 1A) using their WLAN interfaces. For example, a family doing shopping at a mall can use their cell phones that are equipped with WLAN interfaces to make sure that all members in the family stays within a reasonable distance to the mom or dad.

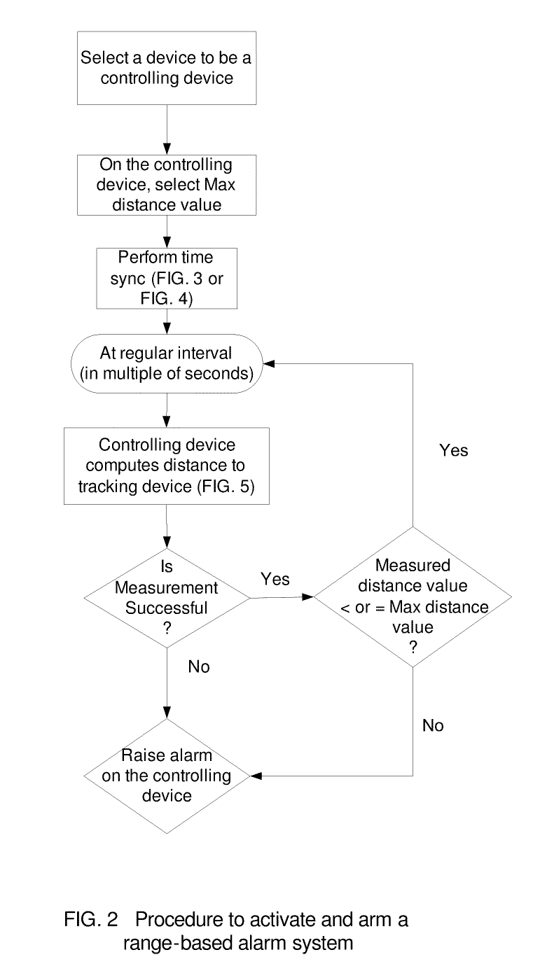

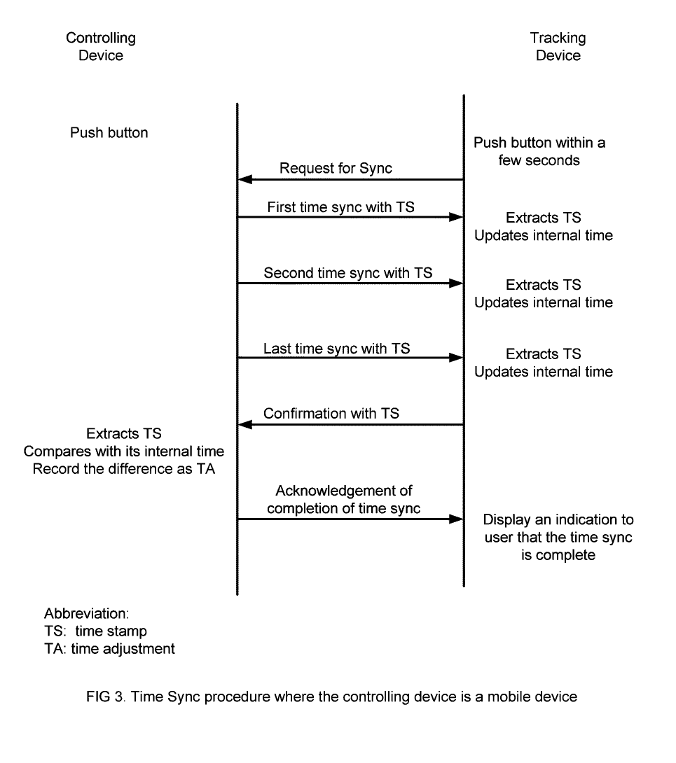

Following the procedure shown in FIG. 2, the first step is to select one of the mobile devices to be the controlling device. The second step is to select the Maximum Distance Value for the controlling device to operate. This value is also known as the range. This is the maximum distance that the tracking devices are allowed to be located from the controlling device without triggering an alarm. The third step is to synchronize the internal time of the tracking device to the internal time of the controlling device (FIG. 3).

The time sync procedure is activated by placing the controlling device physically close to a tracking device and press the time-sync button on the controlling device first, followed by pressing the time-sync button on a tracking device within a few seconds. On smart phones or handheld devices, the time-sync buttons can be replaced by a code, usually consists of two or more digits. The code is first entered into the device that is chosen to be the controlling device, and then users of other devices enter the same code on their devices within a few seconds after.

Continue with FIG. 3, the tracking device sends a request to the controlling device for time sync, the controlling device responds with a number of time-sync data packets, each packet includes a time stamp that indicates the time the packet is transmitted from the controlling device. The tracking device extracts the time stamp from the incoming packet and overwrites its internal time with the received time stamp. This process is repeated until that last time-sync packet is received. The number of time-sync packets transmitted from the controlling device can vary from 1 to n. In most situations, one time-sync packet would be sufficient. The repeated transmission of the time-sync packets is designed to minimize the processing delay at the receivers.

Continued with FIG. 3, the last time-sync packet includes a special code. The tracking device recognizes the last time-sync packet, then sends a confirmation packet to the controlling device with a time stamp. The controlling device receives the confirmation packet, extracts the time stamp and compares it with its internal time. If the time stamp received is faster than its internal time, it subtracts its internal time from the received time stamp to come up with a time adjustment (TA) that will be used to subtract from the time stamps received from this tracking device. On the other hand, if the time stamp received is slower than its internal time, it subtracts the received time stamp from its internal time to come up with a time adjustment (TA) that will be used to add to the time stamps received from this tracking device.

Finally, the controlling device sends an acknowledgement of time-sync completion to the tracking device. Both devices provide indications to the users that the time-sync has been successful and the alarm is activated for the tracking device.

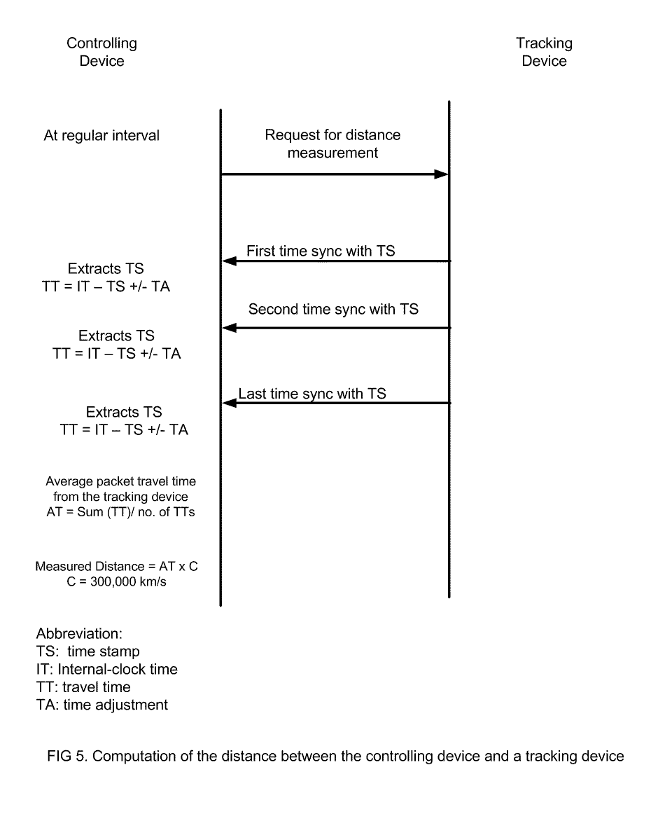

Continued with FIG. 2, after the controlling device and the tracking device successfully performed the time-sync procedure, at regular interval, the controlling device initiates the procedure to compute the distance between itself and the tracking device as shown in FIG. 5. The controlling device issues a request for distance measurement to the tracking device, which in turns responds with a number of time-sync packets. The number of time-sync packets transmitted from the tracking device can vary from 1 to n. In most situations, one time-sync packet would be sufficient. The repeated transmission of the time-sync packets is designed to minimize the processing delay at the receiver and alleviate the effect on signal reflection as discussed in the Background section. The controlling device extracts the time stamps from the incoming packets coming from the tracking device and computes the time for the packet to travel from the tracking device to the controlling device according to the following equation:

TT=IT−TS+/−TA
Where TT=travel time, IT is the internal time of the controlling device, TS is the received time stamp, and TA is the time adjustment for this tracking device as previously calculated.
Depending on the number of packets received, TT is computed for each received packet, then the average travel time (AT) is derived by the following equation:

AT=sum(TTs)/no. of packets received

Finally, the distance between the controlling device is

Computed distance=AT(sec)×300,000 km/sec
If the accuracy of the clocks used on both of the controlling and tracking devices is in order of a nanosecond, then each nanosecond is equivalent to a distance of 0.3 meter or 0.98 foot.

The controlling device checks if the value of the computed distance is less than or equal to the maximum distance value, then it will move on to compute the distance of the next tracking device. If the value of the computed distance is more than the maximum distance value, it raises an alarm indicating that this tracking device has exceeded the maximum distance value.

If the procedure of FIG. 2 does not complete successfully, the controlling device will abandon the computational procedure and will return to perform the distance measurement at the next interval. If the second attempt still does not complete successfully, the controlling device raises an alarm indicating that it has encountered communication with the tracking device.

On a tracking device, if it does not receive any request for distance measurement for a period of time that exceeds two regular intervals, it will raise a local alarm on the tracking device indicating that it has lost communication with the controlling device.

FIG. 1B is a block diagram of another embodiment of a range-based wireless alarm system in accordance with the invention, wherein the controlling device is installed at a fixed location and other devices are mobile devices. For examples, the controlling device is installed on the wall of a hotel or a residential home for the purpose of tracking people, automobiles, animals and devices such as laptop, cell phones that are all equipped with WLAN interfaces. Pushing the button on the controlling device to activate the time-sync procedure may not be practical. Instead, the time sync procedure can be triggered by a remote control or by a command that is sent via a cable connected to the Ethernet port of the controlling device. After the time-sync command is received, the controlling device of FIG. 1B operates the same way as the controlling device of FIG. 1A.

What is claimed is:

1. An alarm system comprised of a controlling device and a plurality of portable and handheld devices in communication with the controlling device over a wireless local area network (WLAN), wherein at each reporting interval, the controlling device computes the distance between itself and the plurality of portable and handheld devices and raises an audible or visual alarm when one of the computed distances exceeds the maximum distance value. The reporting interval and the maximum distance value are set by the user on the controlling device. The controlling device may display in real-time the computed distances on its video display unit if it is available.

2. A method of synchronizing the clocks between two portable devices operating in a WLAN, wherein the first device is the controlling device and the second device is the tracking device, comprised of the following steps:
a.) Placing both devices in close proximity, pushing a time-sync button on the controlling device, and then pushing the time-sync button of the tracking device within a few seconds.
b.) The tracking device transmits a request for synchronization. The controlling device validates the source address of the tracking device and responds with a number of time-sync data packets. Each time-sync data packet carries the time stamp of when the packet is transmitted. The number of time-sync packets transmitted from the controlling device is varied and the last packet is marked by a special identification code.
c.) The tracking device receives a time-sync packet from the controlling device, extracts the time stamp and updates its internal clock time with the received time stamp.
d.) After receiving the last time-sync packet from the controlling device, the tracking device transmits a confirmation-packet with a time stamp that indicates the time the packet is transmitted.
e.) The controlling device extracts the time stamp from the confirmation packet and subtracts this time stamp from its internal time. If the result is non-zero, the controlling device stores this value (TA) in its memory to be used for adjusting the times of packets transmitted from this tracking device.
f.) The controlling device sends an acknowledgement packet to the tracking device indicating that the clock synchronization process is complete.
g.) The tracking device receives the acknowledgement packet from the controlling device, displays a visual indication to the user that the synchronization with the controlling device is successful.

3. A method of synchronizing the clocks between a two mobile devices such as cell phones, smart phones, handheld devices, communicating via a WLAN, comprised of the method of claim 2 wherein the step a.) is replaced by the following step:
a.) The first user enters a code using the keypad of the controlling device, and then second user enters a code using the keypad of the tracking device within a few seconds.

4. A method of synchronizing the clocks between a device that is stationary and a portable or mobile device communicating via a WLAN, comprised of the method of claim 2 wherein the stationary device is the controlling device and the portable device is the tracking device and with the step a.) replaced by the following step:
a.) The user moves the portable, mobile device to within the supported range of the stationary device then pushes the time-sync button on the portable or mobile device momentarily.

5. A method of synchronizing the clocks between a device that is stationary and a portable or mobile device communicating via a WLAN, comprised of the method of claim 2 wherein the stationary device is the controlling device and the portable or mobile device is the tracking device and with the step a.) replaced by the following step:
a.) The first user sends a command to the controlling device via its Ethernet port or a remote control device. The second user presses the time-sync button on the tracking device.

6. A method to compute the distance between two devices of claim 2 in a WLAN, wherein the first device is a controlling device and the second device is a tracking device, comprised of the following steps:
a.) The controlling device transmits a request for distance measurement to the tracking device.
b.) The tracking device transmits a number of time-sync packets in response to the request for distance measurement from the controlling device. Each time-sync packet includes a time stamp that indicates the time the packet is transmitted. The number of time-sync packets transmitted is varied but the last packet is indicated by a special identification code.
c.) For each receiving time-sync packet, the controlling device retrieves the time stamp (TS) of the incoming packet and calculates the time the packet took (TT) to travel from the tracking device to the controlling device by subtracting TS from its internal time (IT)
TT=IT−TS+/−TA
d.) The average traveling time of a packet (AT) from the tracking device to the controlling device is equal to the sum of all travel times divided by the number of packets (n) received by the tracking device
AT=sum(TT)/n
e.) The distance from the controlling device to the tracking device is computed by the formula
L=AT×C (kms)
Where C=300,000 km/s, the speed of light

7. The controlling device and a plurality of personal and handheld devices of claim 1, wherein the controlling device, which is a portable device, performs the methods of claim 2 and claim 6 to form a range-based wireless alarm system.

8. The controlling device and a plurality of personal and handheld devices of claim 1, wherein the controlling device, which is a portable device, performs the methods of claim 3 and claim 6 to form a range-based wireless alarm system.

9. The controlling device and a plurality of personal and handheld devices of claim 1, wherein the controlling device, which is a stationary device, performs the methods of claim 4 and claim 6 to form a range-based wireless alarm system.

10. The controlling device and a plurality of personal and handheld devices of claim 1, wherein the controlling device, which is a stationary device, performs the methods of claim 5 and claim 6 to form a range-based wireless alarm system.

11. The controlling device and tracking devices of claim 7, wherein if the controlling device finds any of the computed distances exceeds its operating range, it immediately performs the following actions:
a.) Raises an audible or visual alarm on its own device;
b.) Displays the identification of the tracking device whose distance from the controlling device exceeds the operating range on its user interface; and
c.) Sends an alert message to the tracking device whose distance from the controlling device exceeds the operating range. Upon receiving the alert message, the tracking device displays the alert message on its user interface or sounds an audible alarm.
Wherein, any tracking device that does not get a request for the distance measurement from the controlling device after two or more consecutive reporting intervals, raises an audible or visual alarm on its user interface with an indication that it has lost communication with the controlling device.

12. The controlling device and tracking devices of claim 8, wherein if the controlling device finds any of the computed distances exceeds its operating range, it immediately performs the following actions:
a.) Raises an audible or visual alarm on its own device;
b.) Displays the identification of the tracking device whose distance from the controlling device exceeds the operating range on its user interface; and
c.) Sends an alert message to the tracking device whose distance from the controlling device exceeds the operating range. Upon receiving the alert message, the tracking device displays the alert message on its user interface or sounds an audible alarm.
Wherein, any tracking device that does not get a request for the distance measurement from the controlling device after two or more consecutive reporting intervals, raises an audible or visual alarm on its user interface with an indication that it has lost communication with the controlling device.

13. The controlling device and tracking devices of claim 9, wherein if the controlling device finds any of the computed distances exceeds its operating range, it immediately performs the following actions:
a.) Raises an audible or visual alarm on its own device;
b.) Displays the identification of the tracking device whose distance from the controlling device exceeds the operating range on its user interface; and
c.) Sends an alert message to the tracking device whose distance from the controlling device exceeds the operating range. Upon receiving the alert message, the tracking device displays the alert message on its user interface or sounds an audible alarm.
Wherein, any tracking device that does not get a request for the distance measurement from the controlling device after two or more consecutive reporting intervals, raises an audible or visual alarm on its user interface with an indication that it has lost communication with the controlling device.

14. The controlling device and tracking devices of claim 10, wherein if the controlling device finds any of the computed distances exceeds its operating range, it immediately performs the following actions:
a.) Raises an audible or visual alarm on its own device;
b.) Displays the identification of the tracking device whose distance from the controlling device exceeds the operating range on its user interface; and
c.) Sends an alert message to the tracking device whose distance from the controlling device exceeds the operating range. Upon receiving the alert message, the tracking device displays the alert message on its user interface or sounds an audible alarm.
Wherein, any tracking device that does not get a request for the distance measurement from the controlling device after two or more consecutive reporting intervals, raises an audible or visual alarm on its user interface with an indication that it has lost communication with the controlling device.

15. The controlling device and tracking devices of claim 7, wherein the controlling device and tracking devices exchange text or alert messages under the control of their users for display on their user interfaces.

16. The controlling device and tracking devices of claim 8, wherein the controlling device and tracking devices exchange text or alert messages under the control of their users for display on their user interfaces.

17. The controlling device and tracking devices of claim 9, wherein the controlling device and tracking devices exchange text or alert messages under the control of their users for display on their user interfaces.

18. The controlling device and tracking devices of claim 10, wherein the controlling device and tracking devices exchange text or alert messages under the control of their users for display on their user interfaces.
